(19) United States
(12) Patent Application Publication
(10) Pub. No.: US 2017/0096846 A1
(43) Pub. Date: Apr. 6, 2017

(54) Direct Drive Truck Box Linkage And Lock

(71) Applicant: Thule, Inc., Seymour, CT (US)

(72) Inventors: Claude NEELY, III, Perry, FL (US); Timothy A. Marshall, Wolcott, CT (US)

(21) Appl. No.: 14/872,940

(22) Filed: Oct. 1, 2015

(51) Int. Cl. E05C 9/10; E05B 1/00; E05C 19/12; E05C 5/00; E05C 19/00

(52) U.S. Cl. CPC E05C 9/10; E05C 5/00; E05C 19/001; E05C 19/12; E05B 1/003

(57) ABSTRACT

A latch arrangement includes at least two handles coupled to one another and configured to transition the latch arrangement between a closed configuration and an open configuration. In the locked position a locking member inhibits actuation of each handle. The handle includes a handle lever configured to rotate a rotational member as the handle moves to the closed configuration. A cam lever is coupled to the rotational member and configured to actuate the cam lever, and a latch cam is coupled to the cam lever. Either handle transitioning between the closed and open configurations causes each latch cam to actuate.

### FIELD

The subject matter herein generally relates to handles. More specifically, the subject matter herein relates to handle arrangements for truck boxes.

### BACKGROUND

Truck boxes can have two handles, each having a locking mechanism. Each handle of the truck box can be capable of independently opening the truck box. The locking mechanism can directly inhibit operation of only the corresponding handle. As such, the truck box can only be secured by locking both handles. When either handle remains unlocked, the entire truck box is unsecured. Unlocking a single handle can allow access to the entire truck box because each handle operates independent of the other.

### BRIEF DESCRIPTION OF THE DRAWINGS

Implementations of the present technology will now be described, by way of example only, with reference to the attached figures.

FIG. 1 is a front view of an exemplary embodiment of a handle arrangement in a locked configuration and a closed position.

FIG. 2 is an isometric view of the back of an exemplary embodiment of a handle arrangement in a locked configuration.

FIG. 3A is a top view of an exemplary embodiment of a handle arrangement in a locked configuration and a closed position.

FIG. 3B is a top view of an exemplary embodiment of a handle arrangement in an unlocked configuration and an open position.

FIG. 4 is an isometric view of an exemplary embodiment of a two handle arrangement in a locked configuration.

FIG. 5 is an enlarged view of circle portion A of FIG. 4.

FIG. 6 is an isometric view of an exemplary embodiment of a handle arrangement in an unlocked configuration and a closed position.

FIG. 7 is an isometric view of the handle arrangement of FIG. 6, transitioning from the closed position to an open position.

FIG. 8 is an isometric view of a two handle arrangement in an unlocked configuration and an open position.

FIG. 9 is an isometric view of a box including the two handle arrangement of FIG. 8, in an unlocked configuration and an open position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series, and the like.

The present disclosure is described in relation to a latch arrangement including at least two handles, each handle coupled to one another and configured to transition the latch arrangement between a closed configuration and an open configuration, a locking member coupled to one handle and transitionable between an unlocked position and a locked position, in the locked position the locking member inhibits actuation of the handle. The handle can include a handle lever coupled to a rotational member and configured to rotate the rotational member as the handle is transitioned between the open configuration and the closed configuration, a cam lever coupled to the rotational member, the rotational member configured to actuate the cam lever, and a latch cam coupled to the cam lever, wherein the cam lever is configured to actuate the latch cam between a first position corresponding to the closed configuration and a second position corresponding to the open configuration. The latch arrangement is configured such that either handle transitioning between the closed configuration and the open configuration causes each latch cam to actuate from the first position to the second position. In at least one embodiment, during the transition, each latch cam can initially move in a direction away from the second position. In at least one embodiment, when the locking member is in a locked position, actuation of the one handle causes the latch cam of the other handle to actuate the latch cam in a direction away from the second position.

In at least one embodiment, each handle has a locking member transitionable between an unlocked position and a locked position.

In at least one embodiment, the at least two handles are coupled to one other by a drive shaft.

In at least one embodiment, each cam lever has a drive shaft coupling the drive shaft to each handle, and the draft shaft actuates laterally relative to the handle arrangement.

In at least one embodiment, the cam lever has a protrusion extending therefrom and the latch cam has a groove formed therein, the protrusion being received within the groove and shaped such that the protrusion engages the groove. In at least one embodiment, as the protrusion engages the groove the latch cam initially moves in a direction away from the second position.

In at least one embodiment, the handle includes a connecting member and a handle lever such that the handle lever engages with the rotational member.

In at least one embodiment, the handle lever has a pin extending therefrom, the pin engaging an inner surface of a protrusion extending from the rotational member, the pin configured to slide along the inner surface as the handle is actuated from a closed configuration to an open configuration.

In at least one embodiment, the latch cam is configured to receive a latch pin.

In at least one embodiment, the latch cam is substantially U-shaped and configured to receive the latch pin with the substantially U-shape.

In at least one embodiment, the handle arrangement has a housing and the latch cam is actuated about a first hub coupled to the housing and the cam lever is actuated about a second hub coupled to the housing.

In at least one embodiment, a spring is disposed around the first hub and the second hub to assist in actuation of the handle arrangement.

In at least one embodiment, a back plate is coupled to the housing by the first hub and the second hub and is disposed between the housing and the latch cam and cam lever.

In at least one embodiment, a guard plate is secured to the first hub and the second hub, the guard plate protecting the actuation of the latch cam and cam lever.

In at least one embodiment, the handle arrangement has a housing and the handle actuates about a securing pin at one end of the handle, the securing pin coupling the handle and the housing.

The present disclosure is also described in relation to a handle arrangement including a cam lever, a drive shaft coupling coupled to the cam lever, a drive shaft coupled to the drive shaft coupling, and a latch cam coupled to the cam lever. The drive shaft can be configured to actuate the cam lever causing the latch cam to actuate between a first position corresponding to a closed configuration and a second position corresponding to an open configuration. In at least one embodiment, the handle arrangement transitioning between the closed configuration and the open configuration can cause the latch cam to transition between from the first position to the second position and the latch cam initially moves in a direction away from the second position.

The present disclosure is also described in relation to a method for operating a handle arrangement including providing a handle arrangement transitionable between a closed configuration and an open configuration, the handle arrangement having a handle, a rotational member, a cam lever, and a latch cam, the cam lever and latch cam coupled to each other, the latch cam having a first position corresponding to the closed configuration and a second position corresponding to the open configuration. In at least one embodiment, transitioning the handle arrangement from the closed configuration to the open configuration such that the cam lever actuates the latch cam from the first position to the second position and the latch cam initially moves in a direction away from the second position.

In at least one embodiment, actuation of the handle can transition the handle arrangement from the closed configuration to the open configuration.

In at least one embodiment, the cam lever can have a drive shaft coupling and a drive shaft coupled to the drive shaft coupling and actuation of the drive shaft can transition the handle arrangement from the closed configuration to the open configuration.

The present disclosure is also described in relation to a handle arrangement including a handle transitionable between an undrawn configuration and a drawn configuration, the handle having a handle lever extending therefrom. The handle lever can be coupled to a rotational member and configured to rotate the rotational member as the handle is transitioned between the undrawn configuration and the drawn configuration. A cam lever can be coupled to the rotational member. The rotational member can be configured to actuate the cam lever. A latch cam can be coupled to the cam lever. The cam lever can be configured to actuate the latch cam between a first position corresponding to the undrawn configuration of the handle, and a second position corresponding to the drawn configuration of the handle. The latch cam can be configured such that transitioning the handle between the undrawn configuration and the drawn configuration causes the latch cam to transition from the first position to the second position. The latch cam can initially move in a direction away from the second position before arriving at the second position.

In at least one embodiment, the handle can include a handle connecting member and a handle lever connected thereto. The handle lever can have a protrusion protruding therefrom at a location distal from the handle.

In at least one embodiment, the handle arrangement can further include a lock shaft. The lock shaft can house a lock. The protrusion can include a post. The post can be situated on the handle lever such that when the handle is transitioned toward the drawn configuration, the post is moved in a direction parallel to a longitudinal axis of the lock shaft.

In at least one embodiment, the handle arrangement can further include a lock shaft. The handle can include a handle connecting member and a handle lever integrally formed therewith. The handle lever can have a cylindrical post extending therefrom. The cylindrical post can engage the rotational member on an edge of the rotational member distal from the lock shaft.

In at least one embodiment, the latch cam can be biased away from the second position when the handle begins to move toward the drawn position.

In at least one embodiment, the latch cam can be connected to a hub having a longitudinal axis forming an axis of rotation for the latch cam. The latch cam can be biased by a loaded spring. The loaded spring can be least be partially coiled around the axis of rotation.

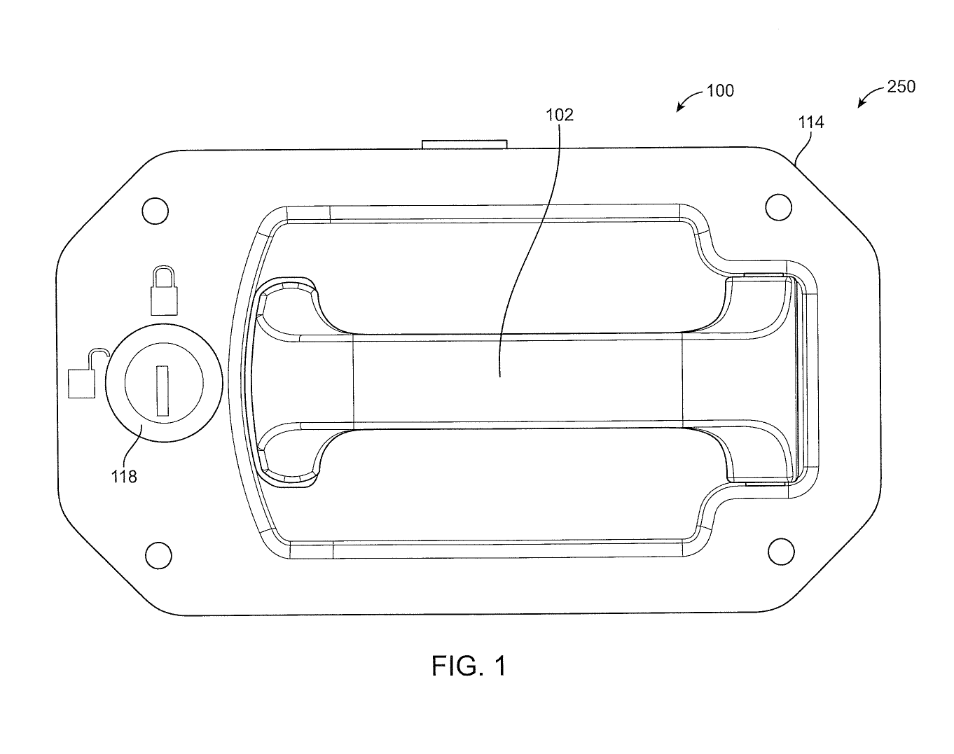

FIG. 1 shows a diagrammatic front view of a handle arrangement 100. The handle arrangement 100 includes a handle 102 coupled to a housing 114, wherein the handle 102 is in a closed position 250. The housing 114 can further include a lock 118 disposed within the housing 114. The lock 118 can be either a physical lock, including, but not limited to, a warded lock, a pin tumbler lock, a tubular lock, a wafer tumbler lock, a disc tumbler lock, or a lever tumbler lock; or an electronic lock, including, but not limited to, a smart lock. When the lock 118 is in the unlocked position, the handle 102 can be rotated about an axis. When the lock 118 is in the locked position, the movement of the handle 102 is restricted.

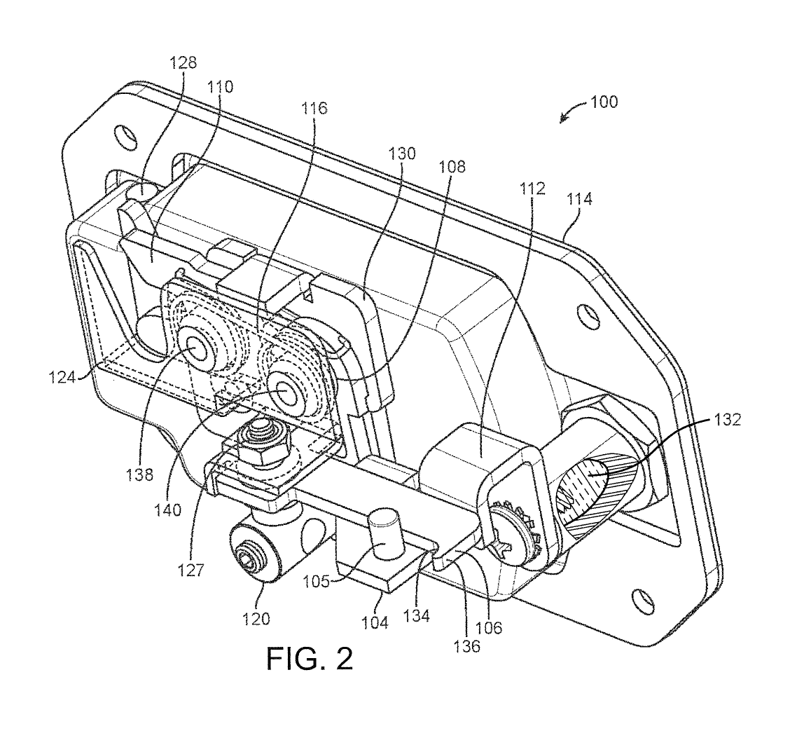

FIG. 2 illustrates the back side of a handle arrangement 100 in a locked configuration. The lock shaft 132 extends outward from the housing 114 and includes a locking member 112 coupled to the distal end of the lock shaft 132. The locking member 112 is configured to abut and, when engaged, prevent the movement of a rotational member 106. The rotational member 106 rests on a handle lever 104 between the distal end of the lock shaft 132 and a handle lever protrusion 105, such that when the handle 102 is actuated and rotates around the handle pin 128, the handle lever 104 moves towards the housing 114. As the handle lever 104 moves towards the housing, an inner surface 134 of a rotational member protrusion 136, extending from a first end of the rotational member 106, catches on the handle lever protrusion 105 such that the handle lever 104 rotates the rotational member 106 towards the housing 114. The rotation occurs around a rotational member axis 127 located at a second end of the rotational member 106. A drive shaft coupling 120 is located below the rotational member 106 and is coupled to a cam lever 108. When actuated, the cam lever 108 rotates about a second hub 140, increasing tension in a spring 116. The rotation of the cam lever 108 around the second hub 140 causes a latch cam 110 to rotate around a first hub 138. The cam lever 108 and latch cam 110 are housed between a back plate 130 and a guard plate 124, which are secured into place by the first hub 138 and second hub 140.

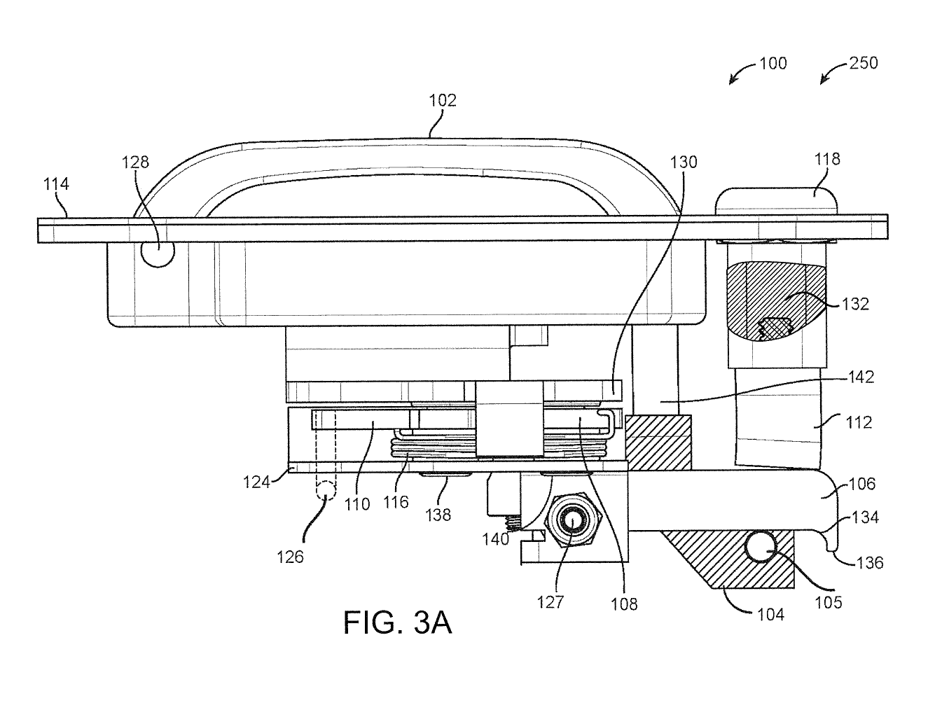

FIG. 3A illustrates a top view of the handle arrangement 100 in a closed position 250. As shown, the handle 102 connects to the handle lever 104 on the opposite side of the housing 114 via the handle connecting member 142. Also shown in FIG. 3A is a latch pin 126, which may couple the latch cam 110 of the handle arrangement 100. FIG. 3B illustrates a top view of the handle arrangement 100 in an unlocked and open position 300. In the unlocked position, the lock 118 has been rotated such that the locking member 112 does not restrict the movement of the rotational member 106. When the lock 118 is in the unlocked position, the handle 102 can be actuated such that the handle 102 rotates about the axis of the handle pin 128, pulling the handle connecting member 142 and the handle lever 104 toward the housing 114. As the handle lever 104 moves towards the housing 114, the inner surface 134 of the rotational member protrusion 136 catches on the handle lever protrusion 105 rotating the rotational member 106 about the rotational member axis 127.

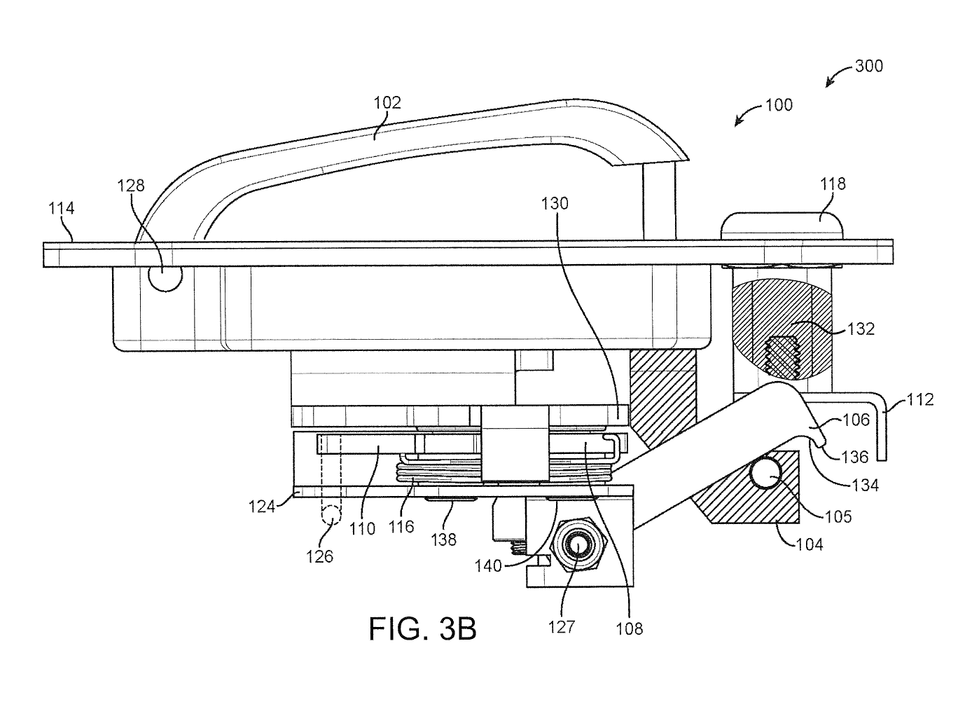

FIG. 4 illustrates an isometric view of a two handle arrangement 200. The two handle arrangement 200 can include two handle arrangements that can be substantially the same. In at least one example, one of the two handle arrangements can have a lock. In other examples, both handle arrangements can have a lock. The two handle arrangement 200 can include a drive shaft 122 that is coupled to the drive shaft coupling 120 of the first handle arrangement and a second drive shaft coupling 121 of the second handle arrangement. The drive shaft 122 can be any suitable means to translate the movement of the drive shaft coupling 120 to the second drive shaft coupling 121 and translate the movement of the second drive shaft coupling 121 to the drive shaft coupling 120. As such, both handle arrangements can be locked or unlocked by locking or unlocking only one of the two handle arrangements.

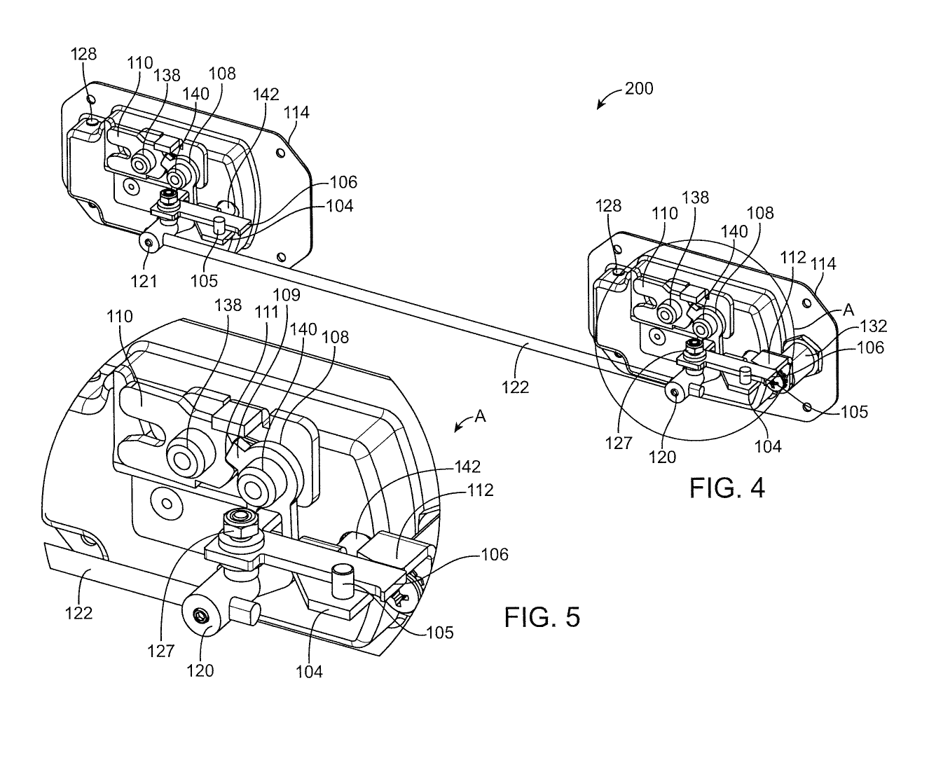

Referring also to FIG. 5, the two handle arrangement 200 is in a locked configuration. To be in the locked configuration, the lock shaft 132 can be rotated such that the locking member 112 can be transitioned to a locked position. When the locking member 112 is in the locked position, the locking member 112 prevents the rotational member 106 from rotating past a predetermined point. Thus, the handle lever 104 can be actuated such that the handle lever protrusion 105 can abut and rotate the rotational member 106. However, the rotational member 106 abuts the locking member 112, preventing the rotational member 106 from rotating past a predetermined point. As such, the movement of the drive shaft coupling 120 is restricted, and due to the drive shaft 122, the movement of the second drive shaft coupling 121 is also restricted. Thus, by locking only one handle arrangement, both handle arrangements are effectively locked.

Alternatively, if the handle 102 of an unlocked handle arrangement is pulled while the other handle arrangement is in the locked configuration, the handle lever protrusion 105 can abut and rotate the rotational member 106 of the unlocked handle arrangement. As such, the second drive shaft coupling 121 is moved. However, the drive shaft 122 translates the movement of the second drive shaft coupling 121 to the drive shaft coupling 120, which causes the rotational member 106 to rotate. As the two handle arrangement 200 is in the locked configuration, the locking member 112 prevents the rotational member 106 from rotating past a predetermined point, restricting the movement of the drive shaft coupling 120. As such, due to the drive shaft 122, the movement of the second drive shaft coupling 121 is also restricted. Thus, both handle arrangements are effectively locked even though only one handle arrangement is in a locked configuration.

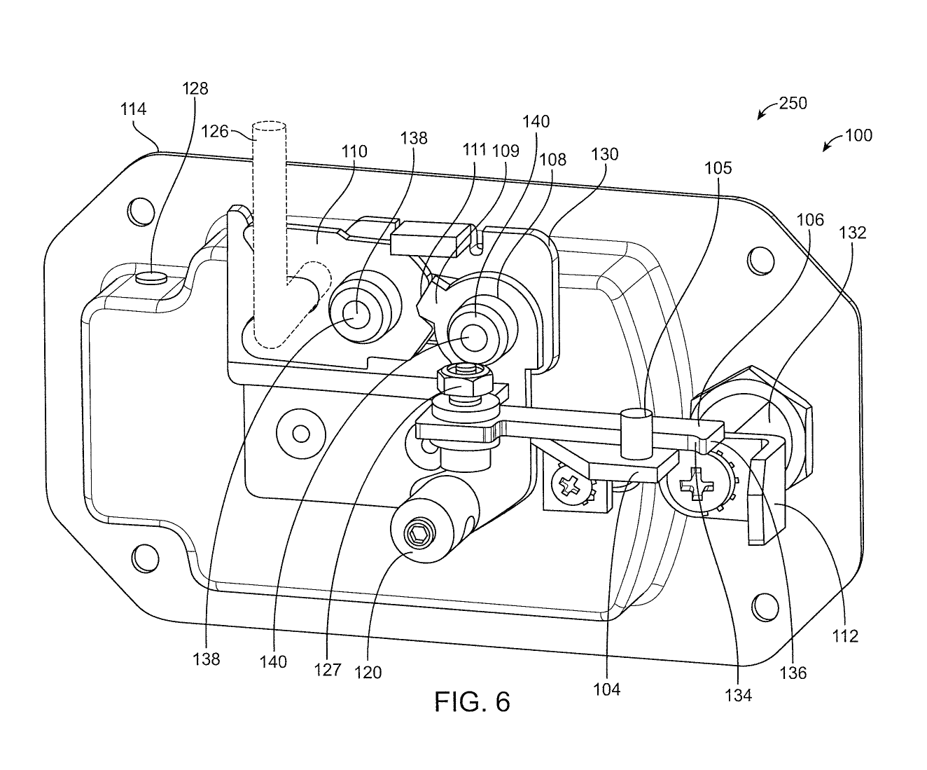

FIG. 6 illustrates a handle arrangement 100 with a lock in an unlocked configuration and a closed position 250. To be in the unlocked configuration, the locking member 112 can be rotated such that the locking member 112 does not restrict the movement of the rotational member 106. In the closed position 250, the cam lever protrusion 109 can be received in the latch cam groove 111. As such, the latch cam 110 can be configured to and positioned to removably couple with and restrict the movement of the latch pin 126. As illustrated in FIG. 6, the latch pin 126 can be an L-shaped rod. The latch pin 126 can be any shape or size suitable to be removably coupled to the latch cam 110. The latch pin 126 can be coupled to a lid such that if the latch pin 126 is removably coupled with the latch cam 110, the movement of the lid is also restricted.

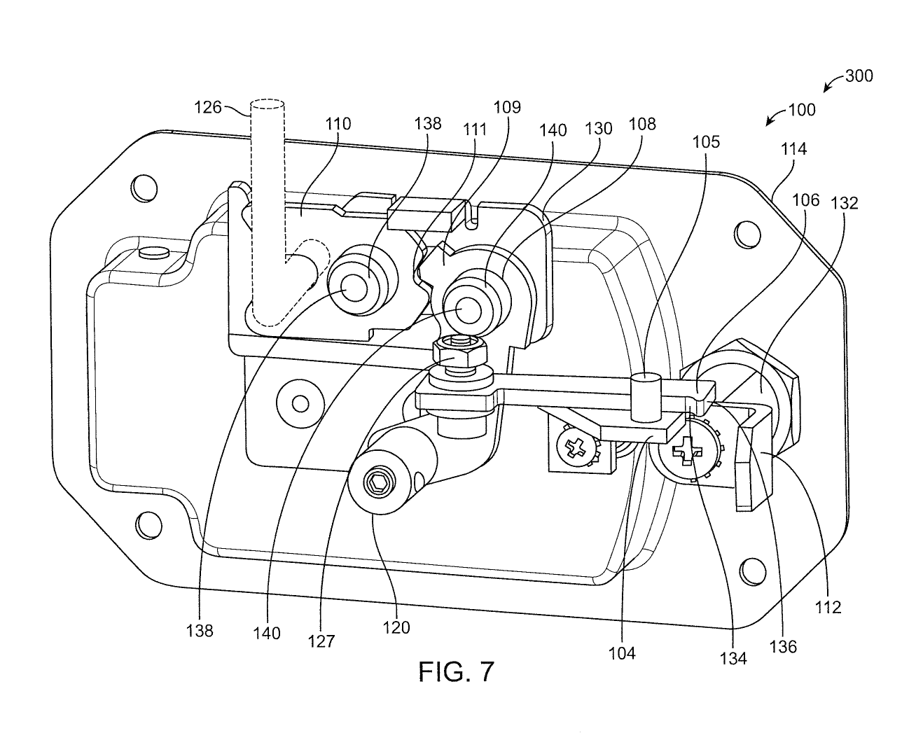

When the handle lever 104 is actuated, the handle lever protrusion 105 can abut and rotate the rotational member 106 to transition the handle arrangement from a closed position 250 to an open position 300 as illustrated in FIG. 7. As the handle arrangement is in the unlocked configuration, the rotational member 106 can rotate without being restricted by the locking member 112. The rotation of the rotational member 106 can actuate the cam lever 108. The cam lever 108 is coupled to the back plate 130 by the second hub 140. When actuated, the cam lever 108 can rotate about the second hub 140. The drive shaft coupling 120 can be coupled to the cam lever 108 such that when the cam lever 108 moves, so does the drive shaft coupling 120. The cam lever 108 can also include a cam lever protrusion 109. The cam lever protrusion 109 can be configured to be received in a latch cam groove 111 of a latch cam 110. The latch cam groove 111 and the cam lever protrusion 109 can be configured such that when the cam lever 108 rotates, the latch cam 110 also rotates. The latch cam 110 can be coupled to the back plate 130 by a first hub 138. The latch cam 110 can rotate about the first hub 138. As described above, the latch cam 110 can be configured to and positioned to removably couple with and restrict the movement of the latch pin 126. In the illustrated example, the latch cam 110 is configured to receive the latch pin 126 in a groove. As such, when the latch cam 110 rotates clockwise, the latch pin 126 can be released. When the latch cam 110 rotates counterclockwise, the latch pin 126 can be restricted. The latch cam groove 111 and the cam lever protrusion 109 can be configured such that when the cam lever 108 begins to rotate, the latch cam 110 first rotates clockwise a predetermined amount to further restrict the latch pin 126 before rotating counterclockwise to release the latch pin 126.

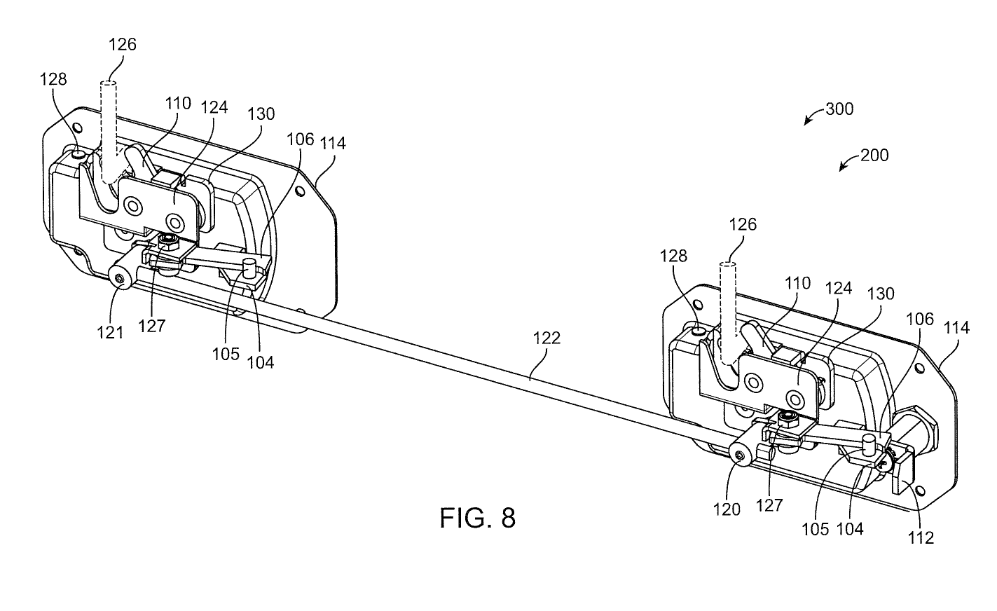

FIG. 8 illustrates a two handle arrangement 200 in an open position 300 where the handle lever 104 is actuated and the latch cam 110 is rotated to release the latch pin 126. The handle lever 104 can be actuated when the handle 102 (shown in FIG. 1) is pulled. A guard plate 124 can be included to protect the operator from one or more moving components. Also, the guard plate 124 can be configured to prevent objects from entering the portion of the handle arrangements that are protected by the guard plate 124. As described earlier, the two handle arrangement 200 can include a drive shaft 122 to translate the movement of the drive shaft coupling 120 to the second drive shaft coupling 121 and translate the movement of the second drive shaft coupling 121 to the drive shaft coupling 120. As such, as the handle lever 104 is actuated, leading to the release of the latch pin 126 in one handle arrangement, the same occurs with the other handle arrangement.

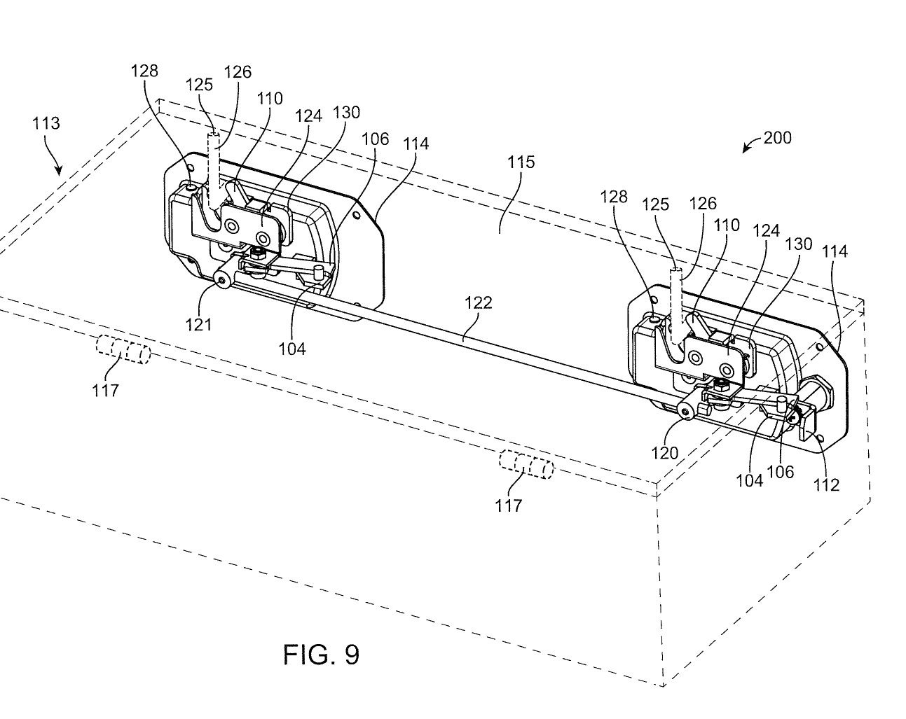

Referring to FIG. 9, two handle arrangements 200 can be included in a box 113. The latch pins 126 can be coupled to a lid 115 of the box 113 by connection regions 125. The box can include hinges 117 that couple the lid 115 to the box 113. The hinges 117 can be coupled to the lid 115 opposite the connection regions 125 of the latch pin 126. The hinges 117 can be door hinges, tee hinges, strap hinges, utility hinges, pin hinges, spring door hinges, or any suitable hinge. When the latch pins 126 are released by the latch cams 110, the lid 115 can be opened by pivoting while being anchored to the box 113 by the hinges 117. The box 113, including the lid 115, can be made of any suitable material such as, but not limited to, steel, aluminum, or plastic.

When the lid 115 is closed, the latch pin 126 can removably couple to the latch cam 110 and rotate the latch cam 110. The cam lever 108 is then rotated such that the cam lever protrusion 109 is received in the latch cam groove 111. Further, the rotational member 106 rotates back toward the closed position 250. The lid 115 then cannot be opened again unless the handle arrangements are in an unlocked configuration and the handle lever 104 is actuated.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure up to, and including, the full extent established by the broad general meaning of the terms used in the claims.

What is claimed is:

1. A latch arrangement, comprising:
at least two handles, each handle coupled to one another and configured to transition the latch arrangement between a closed configuration and an open configuration;
a locking member coupled to one handle and transitionable between an unlocked position and a locked position, such that in the locked position the locking member inhibits actuation of each handle;
wherein a first handle comprises:
a handle lever coupled to a rotational member and configured to rotate the rotational member as the handle is transitioned between the open configuration and the closed configuration;
a cam lever coupled to the rotational member, the rotational member configured to actuate the cam lever; and
a latch cam coupled to the cam lever,
wherein the cam lever is configured to actuate the latch cam between a first position corresponding to the closed configuration and a second position corresponding to the open configuration;
wherein either handle transitioning between the closed configuration and the open configuration causes each latch cam to actuate from the first position to the second position, and
wherein when the locking member is in a locked position, actuating the other handle causes the latch cam of the other handle to actuate the latch cam.

2. The latch arrangement of claim 1, wherein each handle has a locking member transitionable between an unlocked position and a locked position.

3. The latch arrangement of claim 1, wherein the handles are coupled to one another by a drive shaft.

4. The latch arrangement of claim 3, wherein each handle has the drive shaft coupled to each cam lever by a drive shaft coupling, and the drive shaft actuates laterally relative to the handle arrangement.

5. The latch arrangement of claim 1, wherein the handle comprises a connecting member and a handle lever, wherein the handle lever engages with the rotational member.

6. The latch arrangement of claim 5, wherein the handle lever has a pin extending therefrom, the pin engaging an inner surface of a protrusion extending from the rotational member, the pin configured to slide along the inner surface as the handle is actuated from the closed configuration to the open configuration.

7. The latch arrangement of claim 1, wherein the latch cam is configured to receive a latch pin.

8. The latch arrangement of claim 7, wherein the latch cam is substantially U-shaped and configured to receive the latch pin with the substantially U-shape.

9. The latch arrangement of claim 1, wherein the handle arrangement has a housing and the latch cam is actuated about a first hub coupled to the housing and the cam lever is actuated about a second hub coupled to the housing.

10. The latch arrangement of claim 9, wherein a spring is disposed around the first hub and the second hub to assist in actuation of the handle arrangement.

11. The latch arrangement of claim 9, wherein a back plate is coupled to the housing by the first hub and the second hub and disposed between the housing and the latch cam and cam lever.

12. The latch arrangement of claim 9, wherein a guard plate is secured to the first hub and second hub, the guard plate protecting the actuation of the latch cam and cam lever.

13. The latch arrangement of claim 1, wherein the handle arrangement has a housing and the handle actuates about a securing pin at one end of the handle, the securing pin coupling the handle and the housing.

14. The latch arrangement of claim 1, wherein when the latch cams actuate from the first position to the second position, each latch cam initially moves in a direction away from the second position.

15. A handle arrangement, comprising:
a cam lever;
a drive shaft coupling coupled to the cam lever;
a drive shaft coupled to the drive shaft coupling; and
a latch cam coupled to the cam lever,
wherein the drive shaft is configured to actuate the cam lever causing the latch cam to actuate between a first position corresponding to a closed configuration and a second position corresponding to an open configuration.

16. A method for operating a handle arrangement, the method comprising:
providing a handle arrangement transitionable between a closed configuration and an open configuration, the handle arrangement having a handle, a rotational member, a cam lever, and a latch cam, wherein the cam lever and latch are cam coupled to each other, the latch cam having a first position corresponding to the closed configuration and a second position corresponding to the open configuration.

17. The method of claim 16, wherein actuation of the handle transitions the handle arrangement from the closed configuration to the open configuration.

18. The method of claim 16, wherein the cam lever has a drive shaft coupling and a drive shaft coupled to the drive shaft coupling and actuation of the drive shaft transitions the handle arrangement from the closed configuration to the open configuration.
